(19) United States
(12) Patent Application Publication
(10) Pub. No.: US 2021/0395865 A1
(43) Pub. Date: Dec. 23, 2021

(54) MAGNETIC ALLOY MATERIAL

(71) Applicant: NEC Corporation, Minato-ku, Tokyo (JP)

(72) Inventors: Yuma IWASAKI, Tokyo (JP); Masahiko ISHIDA, Tokyo (JP); Akihiro KIRIHARA, Tokyo (JP); Koichi TERASHIMA, Tokyo (JP); Ryohto SAWADA, Tokyo (JP); Hiroko SOMEYA, Tokyo (JP); Yasutomo OMORI, Tokyo (JP)

(73) Assignee: NEC Corporation, Minato-ku, Tokyo (JP)

(21) Appl. No.: 17/296,360

(22) PCT Filed: Nov. 21, 2019
(86) PCT No.: PCT/JP2019/045595

§ 371 Date: May 24, 2021

(30) Foreign Application Priority Data
Nov. 30, 2018 (JP) 2018-224571

(51) Int. Cl. C22C 38/10; H01F 1/047

(52) U.S. Cl. CPC C22C 38/10; C22C 2202/02; H01F 1/047

(57) ABSTRACT

A magnetic alloy material that includes iron and cobalt as main components and at least one element selected from the group containing of platinum, gold, and iridium.

### TECHNICAL FIELD

The present invention relates to a magnetic alloy material.

### BACKGROUND ART

In regard to a magnetic alloy material with a large spin moment which is one of the parameters that determine the strength of a magnet such as magnetic flux density and saturation magnetization, progress has been made toward various applications such as magnetic head, motor, and permanent magnet.

NPL 1 discloses an iron-cobalt alloy (hereinafter referred to as “FeCo alloy”) as a magnetic alloy material having a large spin moment. NPL 1 discloses that the spin moment of an FeCo alloy reaches a maximum when the atomic ratio of iron (Fe) to cobalt (Co) is about 0.75:0.25.

PTL 1 discloses an iron-neodymium-boron alloy (hereinafter referred to as “NdFeB alloy”) as a magnetic alloy material having a large spin moment.

PTL 2 discloses an iron-cobalt-palladium alloy (hereinafter referred to as FeCoPd alloy) as a magnetic material having a large spin moment.

PTL 3 discloses an FeCo alloy containing 4 to 20 at % of an element containing one or more kinds of rare earth elements.

PTL 4 discloses a method for producing a magnetic plated thin film containing an FeCoM alloy to which an element M other than Fe and Co is added.

PTL 5 discloses iron nitride (hereinafter referred to as “FeN compound phase”) as a magnetic material having a large spin moment.

### CITATION LIST

### Patent Literature

[PTL 1] JP 2008-117855 A
[PTL 2] JP 2005-347688 A
[PTL 3] JP 2000-150215 A
[PTL 4] JP 2003-034891 A
[PTL 5] JP 2015-019050 A

### Non Patent Literature

[NPL 1] C. Takahashi, et al., “First-principles calculation of the Curie temperature Slater-Pauling curve,” J. Phys.: Condens. Matter 19, (2007) 365233 (6PP)

### SUMMARY OF INVENTION

### Technical Problem

The NdFeB alloy disclosed in PTL 1 is applied to various fields as a permanent magnet due to not only its large spin moment but also its large coercive force. However, the NdFeB alloy in PTL 1 has a smaller spin moment than an FeCo alloy at room temperature.

PTL 2 says that adding a small amount of palladium (Pd) to an FeCo alloy enables saturation magnetization larger than that of an FeCo alloy. Although values of the saturation magnetization and spin moment are roughly proportional, values of the saturation magnetization derived from experiments and values of the spin moment derived from the first-principles calculation may not be proportional due to influences of experimental errors and the like.

According to PTL 3 and PTL 4, it is possible to achieve a magnetic material having a large spin moment but it is difficult to achieve a magnetic material having a spin moment that surpasses the spin moment of an FeCo alloy in which the composition ratio of Fe to Co is 0.75:0.25.

The FeN compound phase disclosed in PTL 5 enables a high coercive force when a Fe₁₆N₂ compound phase contains equal to or more than 70 atomic percent (hereinafter referred to as “at %”) and equal to or less than 95 at % of Fe or when a Fe₄N compound phase contains equal to or more than 5 at % and equal to or more than 30 at % of Fe in a Mössbauer spectrum. However, the FeN compound phase disclosed in PTL 5 contains nitrogen (N) which is a non-metal, and the phase is separated at about 200° C. Therefore, it is difficult to form the FeN compound phase by sintering, leading to difficulties in production and application.

An object of the present invention is to provide a magnetic alloy material which contains a metallic element as a main component and enables a spin moment larger than that of an iron-cobalt alloy and is easy to manufacture.

### Solution to Problem

A magnetic alloy material according to an aspect of the present invention contains iron and cobalt as main components and at least one element selected from the group consisting of platinum, gold, and iridium.

### Advantageous Effects of Invention

According to the present invention, there is provided a magnetic alloy material which contains a metallic element as a main component and enables a larger spin moment than that of an iron-cobalt alloy and is easy to produce.

### BRIEF DESCRIPTION OF DRAWINGS

FIG. 1 is a conceptual diagram of a magnetic alloy material according to a first example embodiment.

FIG. 2 is a graph showing results calculated by the Korringa Kohn Rostoker Coherent Potential Approximation (KKR-CPA) in regard to the spin moment of the magnetic alloy material according to the first example embodiment.

FIG. 3 is a conceptual diagram of a magnetic alloy material according to a second example embodiment.

FIG. 4 is a graph showing results calculated by the KKR-CPA in regard to the spin moment of the magnetic alloy material according to the second example embodiment.

FIG. 5 is a conceptual diagram of a magnetic alloy material according to a third example embodiment.

FIG. 6 is a graph showing results calculated by the KKR-CPA in regard to the spin moment of the magnetic alloy material according to the third example embodiment.

FIG. 7 is a conceptual diagram of a magnetic alloy material according to a fourth example embodiment.

FIG. 8 is a graph showing results calculated by the KKR-CPA in regard to the spin moment of the magnetic alloy material according to the fourth example embodiment.

FIG. 9 is a graph showing results calculated by the KKR-CPA in regard to the spin moment of a magnetic alloy material according to the related art.

FIG. 10 is a graph showing results calculated by the KKR-CPA in regard to the spin moment of a magnetic alloy material according to the related art.

### EXAMPLE EMBODIMENT

Hereinafter, an example embodiment of the present invention will be described with reference to the drawings. Although the following example embodiments are technically preferable for carrying out the present invention, the scope of the invention is not limited thereto. In all the drawings used for describing the following example embodiments, similar parts are denoted with the same reference numerals unless otherwise noted. Furthermore, in the following example embodiments, similar configurations and operations may not be described repeatedly.

In the following example embodiments, the Korringa Kohn Rostoker Coherent Potential Approximation (KKR-CPA), one of the first-principles calculation methods, is employed to calculate the spin moment of a magnetic alloy. The KKR-CPA is based on a Green function. Specifically, the following example embodiments show results of the spin moment of an alloy calculated with software called AkaiKKR. The software AkaiKKR calculates first-principles electronic states based on the local density approximation or the generalized gradient approximation of the density functional theory.

### First Example Embodiment

First, a magnetic alloy material according to a first example embodiment will be described with reference to the drawings. The magnetic alloy material of the present example embodiment is an iron-cobalt-platinum alloy (hereinafter referred to as “FeCoPt alloy”).

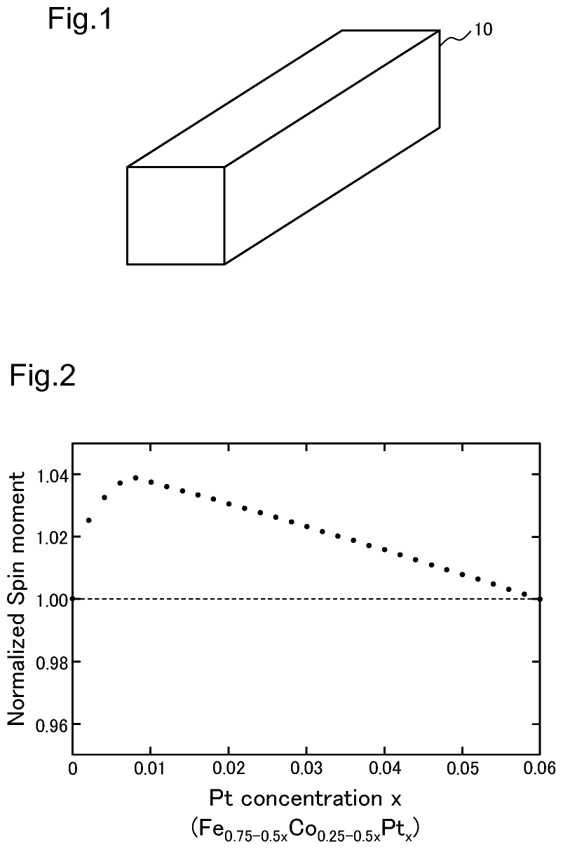

FIG. 1 is a conceptual diagram of a magnetic alloy material 10 according to the present example embodiment. The magnetic alloy material 10 is a material in which platinum (Pt) is added to an iron-cobalt alloy (hereinafter referred to as “FeCo alloy”). For example, the magnetic alloy material 10 contains equal to or more than 0.1 at % of Pt.

FIG. 2 is a graph showing a relation between the concentration (atomic composition) and the spin moment of Pt in FeCoPt alloys (Fe_{0.75-0.5x}Co_{0.25-0.5x}Ptₓ) (0≤x≤0.5). The Pt concentration x in each FeCoPt alloy is taken along the abscissa in FIG. 2. The spin moment of each FeCoPt alloy (Fe_{0.75-0.5x}Co_{0.25-0.5x}Ptₓ) normalized by the spin moment of an FeCo alloy (Fe_{0.75}Co_{0.25}) is taken along the ordinate in FIG. 2.

As shown in FIG. 2, when a small amount of Pt is added to Fe_{0.75}Co_{0.25} (x=0), the spin moment of Fe_{0.75-0.5x}Co_{0.25-0.5x}Ptₓ becomes larger than that of Fe_{0.75}Co_{0.25} (x=0). The spin moment of Fe_{0.75-0.5x}Co_{0.25-0.5x}Ptₓ is larger than that of Fe_{0.75}Co_{0.25} (x=0) when the composition ratio of Pt is within a range of 0<x<0.06. The spin moment of Fe_{0.75-0.5x}Co_{0.25-0.5x}Ptₓ reaches a maximum when the composition ratio of Pt to Fe_{0.75}Co_{0.25} becomes around 0.008 (0.8 at %). In other words, among the FeCoPt alloys, Fe_{0.746}Co_{0.246}Pt_{0.008} has the largest spin moment.

According to the graph of FIG. 2, the magnetic alloy material 10 is preferably Fe_{0.75-0.5x}Co_{0.25-0.5x}Ptₓ containing Fe_{0.75}Co_{0.25} (x=0) as a matrix and Pt having an atomic composition of 0<x<0.06. In particular, according to the graph of FIG. 2, the magnetic alloy material 10 is optimally Fe_{0.746}Co_{0.246}Pt_{0.008}. The composition ratio of Fe_{0.75-0.5x}Co_{0.25-0.5x}Ptₓ used for the magnetic alloy material 10 is not limited to one described above as long as Pt is added to such an extent not to affect the thermal properties of the FeCo alloy. Furthermore, Fe_{0.75-0.5x}Co_{0.25-0.5x}Ptₓ used for the magnetic alloy material 10 may contain elements other than Pt.

The magnetic alloy material 10 of the present example embodiment can be produced by various methods. The magnetic alloy material 10 of bulk type can be produced by, for example, sintering or arc melting. Furthermore, the magnetic alloy material 10 of thin film type can be produced by, for example, sputtering, vapor deposition, and pulsed laser deposition.

As described above, in the magnetic alloy material of the present example embodiment, Pt is added to an FeCo alloy containing Fe and Co as main components. An FeCoPt alloy to which 6 at % or less of Pt is added has a spin moment larger than that of the FeCo alloy.

The addition of a small amount of Pt to the FeCo alloy enables the magnetic alloy material of the present example embodiment to have a larger spin moment than the FeCo alloy. Since Pt is added to the magnetic alloy material of the present example embodiment to such an extent not to affect the thermal properties of the FeCo alloy, the magnetic alloy material of the present example embodiment is practically produced and applied. In other words, according to the present example embodiment, there is provided a magnetic alloy material which contains a metallic element as a main component and has a larger spin moment than that of the FeCo alloy and is easy to produce.

### Second Example Embodiment

Next, a magnetic alloy material according to a second example embodiment will be described with reference to the drawings. The magnetic alloy material of the present example embodiment is an iron-cobalt-gold alloy (hereinafter referred to as “FeCoAu alloy”). The magnetic alloy material of the present example embodiment is different from the magnetic alloy material of the first example embodiment in that gold (Au) is used instead of platinum (Pt).

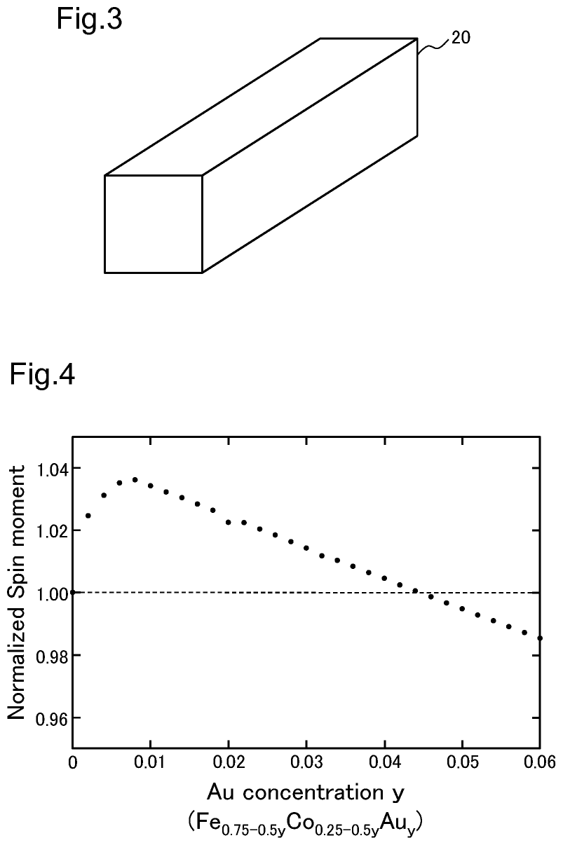

FIG. 3 is a conceptual diagram of a magnetic alloy material 20 according to the present example embodiment. The magnetic alloy material 20 is a material in which gold (Au) is added to an iron-cobalt alloy (hereinafter referred to as “FeCo alloy”). For example, the magnetic alloy material 20 contains equal to or more than 0.1 at % of Au.

FIG. 4 is a graph showing a relation between the concentration (atomic composition) and the spin moment of Au in FeCoAu alloys (Fe_{0.75-0.5y}Co_{0.25-0.5y}Au_{y}) (y is a positive real number). The Au concentration y in each FeCoAu alloy is taken along the abscissa in FIG. 4. The spin moment of each FeCoAu alloy (Fe_{0.75-0.5y}Co_{0.25-0.5y}Au_{y}) normalized by the spin moment of an FeCo alloy (Fe_{0.75}Co_{0.25}) is taken along the ordinate in FIG. 4.

As shown in FIG. 4, when a small amount of Au is added to Fe_{0.75}Co_{0.25} (y=0), the spin moment of Fe_{0.75-0.5y}Co_{0.25-0.5y}Au_{y} becomes larger than that of Fe_{0.75}Co_{0.25} (y=0). The spin moment of Fe_{0.75-0.5y}Co_{0.25-0.5y}Au_{y} is larger than that of Fe_{0.75}Co_{0.25} (y=0) when the composition ratio of Au is within a range of 0<y<0.044. The spin moment of Fe_{0.75-0.5y}Co_{0.25-0.5y}Au_{y} reaches a maximum when the composition ratio of Au to Fe_{0.75}Co_{0.25} becomes around 0.008 (0.8 at %). In other words, among the FeCoAu alloys, Fe_{0.746}Co_{0.246}Au_{0.008} has the largest spin moment.

According to the graph of FIG. 4, the magnetic alloy material 20 is preferably Fe_{0.75-0.5y}Co_{0.25-0.5y}Au_{y} containing Fe_{0.75}Co_{0.25} (y=0) as a matrix and Au having an atomic composition of 0<y<0.044. In particular, according to the graph of FIG. 4, the magnetic alloy material 20 is optimally Fe_{0.746}Co_{0.246}Au_{0.008}. The composition ratio of Fe_{0.75-0.5y}Co_{0.25-0.5y}Au_{y} used for the magnetic alloy material 20 is not limited to one described above as long as Au is added to such an extent not to affect the thermal properties of the FeCo alloy. Furthermore, Fe_{0.75-0.5y}Co_{0.25-0.5y}Au_{y} used for the magnetic alloy material 20 may contain elements other than Au.

The magnetic alloy material 20 of the present example embodiment can be produced by various methods. The magnetic alloy material 20 of bulk type can be produced by, for example, sintering or arc melting. Furthermore, the magnetic alloy material 20 of thin film type can be produced by, for example, sputtering, vapor deposition, and pulsed laser deposition.

As described above, in the magnetic alloy material of the present example embodiment, Au is added to an FeCo alloy containing Fe and Co as main components. An FeCoAu alloy to which 4.4 at % or less of Au is added has a spin moment larger than that of the FeCo alloy.

The addition of a small amount of Au to the FeCo alloy enables the magnetic alloy material of the present example embodiment to have a larger spin moment than the FeCo alloy. Since Au is added to the magnetic alloy material of the present example embodiment to such an extent not to affect the thermal properties of the FeCo alloy, the magnetic alloy material of the present example embodiment is practically produced and applied. In other words, according to the present example embodiment, there is provided a magnetic alloy material which contains a metallic element as a main component and has a larger spin moment than that of the FeCo alloy and is easy to produce.

### Third Example Embodiment

Next, a magnetic alloy material according to a third example embodiment will be described with reference to the drawings. The magnetic alloy material of the present example embodiment is an iron-cobalt-iridium alloy (hereinafter referred to as “FeCoIr alloy”). The magnetic alloy material of the present example embodiment is different from the magnetic alloy materials of the first and second example embodiments in that iridium (Ir) is used instead of platinum (Pt) or gold (Au).

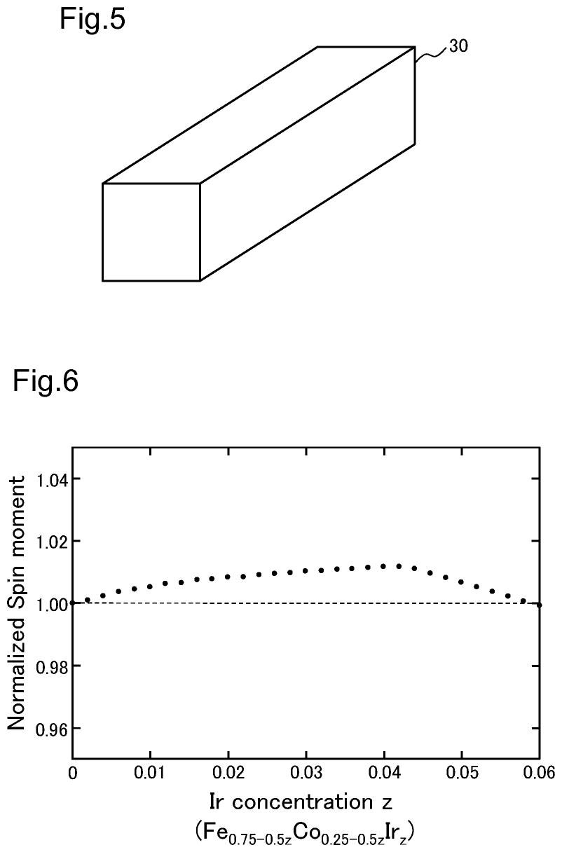

FIG. 5 is a conceptual diagram of a magnetic alloy material 30 according to the present example embodiment. The magnetic alloy material 30 is a material in which iridium (Ir) is added to an iron-cobalt alloy (hereinafter referred to as “FeCo alloy”). For example, the magnetic alloy material 30 contains equal to or more than 0.1 at % of Ir.

FIG. 6 is a graph showing a relation between the concentration (atomic composition) and the spin moment of Ir in FeCoIr alloys (Fe_{0.75-0.5z}Co_{0.25-0.5z}Ir_{z}) (z is a positive real number). The Ir concentration z in each FeCoIr alloy is taken along the abscissa in FIG. 6. The spin moment of each FeCoIr alloy (Fe_{0.75-0.5z}Co_{0.25-0.5z}Ir_{z}) normalized by the spin moment of an FeCo alloy (Fe_{0.75}Co_{0.25}) is taken along the ordinate in FIG. 6.

As shown in FIG. 6, when a small amount of Ir is added to Fe_{0.75}Co_{0.25} (z=0), the spin moment of Fe_{0.75-0.5z}Co_{0.25-0.5z}Ir_{z} becomes larger than that of Fe_{0.75}Co_{0.25} (z=0). The spin moment of Fe_{0.75-0.5z}Co_{0.25-0.5z}Ir_{z} is larger than that of Fe_{0.75}Co_{0.25} (z=0) when the composition ratio of Ir is within a range of 0<z<0.058. The spin moment of Fe_{0.75-0.5z}Co_{0.25-0.5z}Ir_{z} reaches a maximum when the composition ratio of Ir to Fe_{0.75}Co_{0.25} becomes around 0.042 (4.2 at %). In other words, among the FeCoIr alloys, Fe_{0.729}Co_{0.229}Ir_{0.042} has the largest spin moment.

According to the graph of FIG. 6, the magnetic alloy material 30 is preferably Fe_{0.75-0.5z}Co_{0.25-0.5z}Ir_{z} containing Fe_{0.75}Co_{0.25} (z=0) as a matrix and Ir having an atomic composition of 0<z<0.058. In particular, according to the graph of FIG. 6, the magnetic alloy material 30 is optimally Fe_{0.729}Co_{0.229}Ir_{0.042}. The composition ratio of Fe_{0.75-0.5z}Co_{0.25-0.5z}Ir_{z} used for the magnetic alloy material 30 is not limited to one described above as long as Ir is added to such an extent not to affect the thermal properties of the FeCo alloy. Furthermore, Fe_{0.75-0.5z}Co_{0.25-0.5z}Ir_{z} used for the magnetic alloy material 30 may contain elements other than Ir.

The magnetic alloy material 30 of the present example embodiment can be produced by various methods. The magnetic alloy material 30 of bulk type can be produced by, for example, sintering or arc melting. Furthermore, the magnetic alloy material 30 of thin film type can be produced by, for example, sputtering, vapor deposition, and pulsed laser deposition.

As described above, in the magnetic alloy material of the present example embodiment, Ir is added to an FeCo alloy containing Fe and Co as main components. An FeCoIr alloy to which 5.8 at % or less of Ir is added has a spin moment larger than that of the FeCo alloy.

The addition of a small amount of Ir to the FeCo alloy enables the magnetic alloy material of the present example embodiment to have a larger spin moment than the FeCo alloy. Since Ir is added to the magnetic alloy material of the present example embodiment to such an extent not to affect the thermal properties of the FeCo alloy, the magnetic alloy material of the present example embodiment is practically produced and applied. In other words, according to the present example embodiment, there is provided a magnetic alloy material which contains a metallic element as a main component and has a larger spin moment than that of the FeCo alloy and is easy to produce.

### Fourth Example Embodiment

Next, a magnetic alloy material according to a fourth example embodiment will be described with reference to the drawings. In the magnetic alloy material of the present example embodiment, at least two kinds of elements selected from the group consisting of platinum (Pt), gold (Au), and iridium (Ir) are added to an iron-cobalt alloy (hereinafter referred to as “FeCo alloy”). The magnetic alloy material 40 contains at least two kinds of elements selected from the group consisting of platinum (Pt), gold (Au), and iridium (Ir). Each of the elements is contained in amount of equal to or more than 0.1 at %.

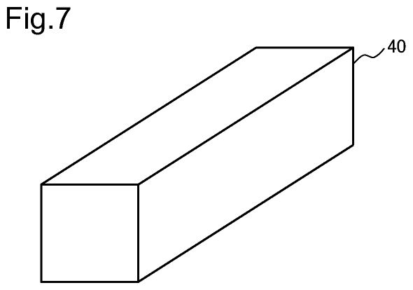

FIG. 7 is a conceptual diagram of a magnetic alloy material 40 according to the present example embodiment. The magnetic alloy material 40 is a material in which at least two kinds of elements selected from the group consisting of platinum (Pt), gold (Au), and iridium (Ir) are added to an iron-cobalt alloy (hereinafter referred to as “FeCo alloy”). In other words, the magnetic alloy material 40 is roughly divided into quaternary materials containing 4 elements and a quinary material containing 5 elements. The quaternary materials are an FeCoPtIr alloy, an FeCoPtAu alloy, and an FeCoAuIr alloy. The quinary material is an FeCoAuPtIr alloy.

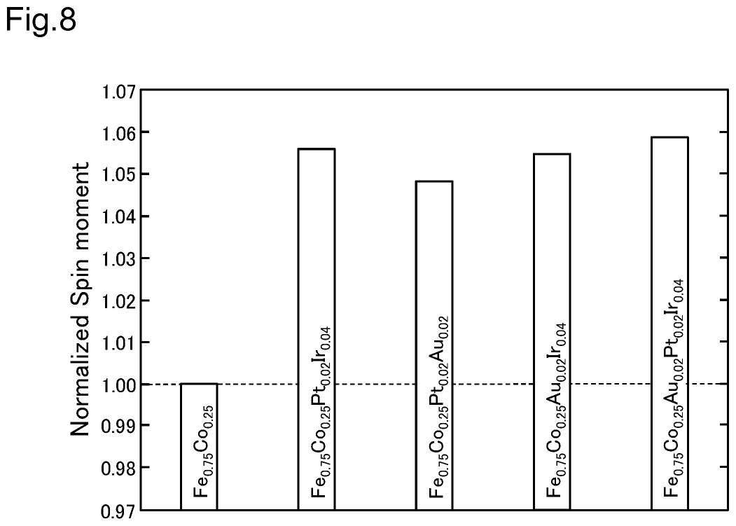

FIG. 8 is a graph for comparing the spin moments between an FeCo alloy and examples of the magnetic alloy material 40. The spin moment of the magnetic alloy material 40 normalized by the spin moment of an FeCo alloy (Fe_{0.75}Co_{0.25}) is taken along the ordinate in FIG. 8. FIG. 8 shows the spin moments of Fe_{0.75}Co_{0.25}Pt_{0.02}Ir_{0.04}, Fe_{0.75}Co_{0.25}Pt_{0.02}Au_{0.02}, and Fe_{0.75}Co_{0.25}Au_{0.02}Ir_{0.04} as the quaternary materials. FIG. 8 also shows the spin moment of Fe_{0.75}Co_{0.25}Pt_{0.02}Au_{0.02}Ir_{0.04} as the quinary material. In FIG. 8, the numeral after each element symbol of the quaternary materials and the quinary material indicates a ratio of the elements included in each material.

As shown in FIG. 8, any of Fe_{0.75}Co_{0.25}Pt_{0.02}Ir_{0.04}, Fe_{0.75}Co_{0.25}Pt_{0.02}Au_{0.02}, Fe_{0.75}Co_{0.25}Au_{0.02}Ir_{0.04}, and Fe_{0.75}Co_{0.25}Pt_{0.02}Au_{0.02}Ir_{0.04} has a larger spin moment than Fe_{0.75}Co_{0.25}. The composition ratio used for the magnetic alloy material 40 is not limited to one shown in FIG. 8 as long as any one of Pt, Au, and Ir is added to such an extent not to affect the thermal properties of the FeCo alloy. The magnetic alloy material 40 may contain elements other than Pt, Au, and Ir.

The magnetic alloy material 40 of the present example embodiment can be produced by various methods. The magnetic alloy material 40 of bulk type can be produced by, for example, sintering or arc melting. Furthermore, the magnetic alloy material 40 of thin film type can be produced by, for example, sputtering, vapor deposition, and pulsed laser deposition.

As described above, in the magnetic alloy material of the present example embodiment, at least two kinds of elements selected from the group consisting of Pt, Au, and Ir are added to an FeCo alloy containing Fe and Co as main components. Each of the elements is contained in amount in amount of equal to or more than 0.1 at %.

The adding of at least two kinds of elements selected from the group consisting of Pt, Au, and Ir to the FeCo alloy in small amounts enables the magnetic alloy material of the present example embodiment to have a larger spin moment than the FeCo alloy. Since at least two kinds of elements selected from the group consisting of Pt, Au, and Ir are added to the magnetic alloy material of the present example embodiment to such an extent not to affect the thermal properties of the FeCo alloy, the magnetic alloy material of the present example embodiment is practically produced and applied. In other words, according to the present example embodiment, there is provided a magnetic alloy material which contains a metallic element as a main component and has a larger spin moment than that of the iron-cobalt alloy and is easy to produce.

The magnetic alloy materials according to the first to fourth example embodiments have been described above. The magnetic material according to each example embodiment contains iron and cobalt as main components and equal to or more than 0.1 at % of at least one element selected from the group consisting of platinum, gold, and iridium. Platinum, gold, and iridium are Groups 9 to 11 Period 6 transition metals (atomic number: 77 to 79) in the periodic table. For example, the magnetic alloy materials according to the first to fourth example embodiments contain cobalt having an atomic composition ratio of equal to or more than 10 at % and equal to or less than 90 at %. For example, the magnetic alloy materials according to the first to fourth example embodiments preferably have an atomic composition ratio of iron to cobalt of 75:25.

(Related Art)

Next, a magnetic alloy material according to the related art will be described with reference to the drawings. Examples of the magnetic alloy material in the related art include an iron-cobalt alloy (hereinafter referred to as “FeCo alloy”) and an iron-cobalt-palladium alloy (hereinafter referred to as “FeCoPd alloy”).

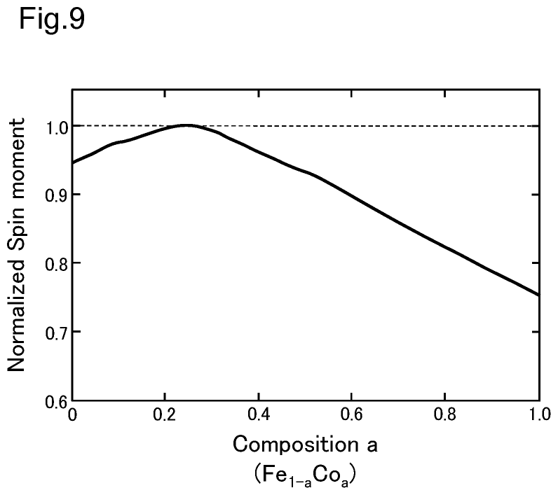

FIG. 9 is a graph showing a relation between the composition ratio (atomic composition ratio) and the spin moment of cobalt (Co) in FeCo alloys (Fe₁₋ₐCoₐ) (a is a positive real number). The composition ratio a of Co in each FeCo alloy is taken along the abscissa in FIG. 9. The spin moment of an FeCo alloy (Fe₁₋ₐCoₐ) normalized by the spin moment of Fe_{0.75}Co_{0.25} is taken along the ordinate in FIG. 9. As shown in FIG. 9, the spin moment of an FeCo alloy (Fe₁₋ₐCoₐ) reaches a maximum when the composition ratio a of Co becomes 0.25.

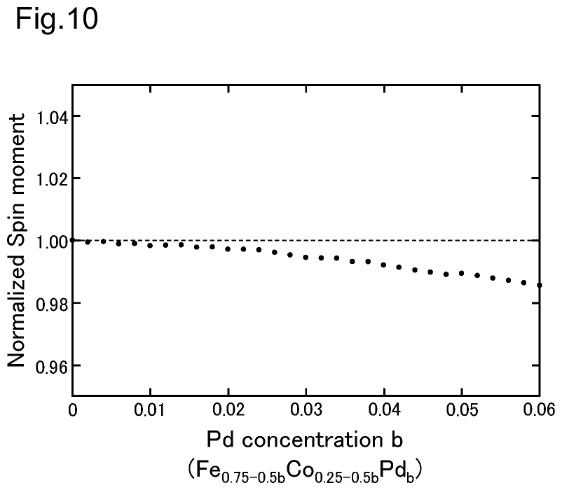

FIG. 10 is a graph showing a relation between the concentration (atomic composition) and the spin moment of palladium (Pd) in FeCoPd alloys (Fe_{0.75-0.5b}Co_{0.25-0.5b}Pd_{b}) (b is a positive real number). The Pd concentration b in each FeCoPd alloy is taken along the abscissa in FIG. 10. The spin moment of each FeCoPd alloy (Fe_{0.75-0.5b}Co_{0.25-0.5b}Pd_{b}) normalized by the spin moment of an FeCo alloy (Fe_{0.75}Co_{0.25}) is taken along the ordinate in FIG. 10.

As shown in FIG. 10, when a small amount of Pd is added to Fe_{0.75}Co_{0.25} (b=0), the spin moment of Fe_{0.75-0.5b}Co_{0.25-0.5b}Pd_{b} tends to decrease with the addition of Pd and does not become larger than that of Fe_{0.75}Co_{0.25} (b=0). Even when changing ratios of iron (Fe) to cobalt (Co), the transformation of the spin moment shown in FIG. 10 differs little.

PTL 2 (JP 2005-347688 A) contains information that the addition of Pd to an FeCo alloy increases saturation magnetization. PTL 2 says that an increase in saturation magnetization is caused by an increase in spin moment based on a change in electronic state which is caused when Pd displaces a lattice point of an FeCo crystal or penetrates between lattices to expand the FeCo crystal lattice structure. However, the result in FIG. 10 shows that the spin moment does not increase even when Pd is added to an FeCo alloy. Therefore, it is inferred that the saturation magnetization in PTL 2 is not caused by an increase in spin moment attributed to a change in electronic state but by an oxidation prevention effect of a magnetic alloy due to the addition of Pd.

On the other hand, in each of the magnetic alloy materials of the first to fourth example embodiments, the spin moment increases when at least one element selected from the group consisting of platinum (Pt), gold (Au), and iridium (Ir) is added to an FeCo alloy. It is inferred that each of the magnetic alloy materials of the first to fourth example embodiments increases in spin moment because of a change in electronic state caused by adding at least one element selected from the group consisting of Pt, Au, and Ir to an FeCo alloy.

Next, methods for producing the magnetic alloy materials according to the first to fourth example embodiments will be described with reference to several Examples. The following methods for producing the magnetic alloy materials are shown schematically, and preparation of materials and usage of production devices are not shown in a precise sense.

### Example 1

Example 1 relates to the first example embodiment. In Example 1, an FeCoPt alloy of bulk type was produced by sintering.

First, metal powders of iron (Fe), cobalt (Co), and platinum (Pt) were blended with an atomic composition ratio of Fe:Co:Pt=0.746:0.246:0.008 and were uniformly mixed with a mortar to prepare a mixed powder.

Next, in a sintering device where argon gas was introduced after vacuum drawing, the prepared mixed powder was subjected to press molding at a pressure of 100 MPa and then sintered at 600° C. to form a sintered body.

Then, the sintered body was diced to a desired size, whereby producing an FeCoPt alloy having the desired size.

At the time of preparing the mixed powder, for example, it is possible to change a coercive force of the FeCoPt alloy and to enhance the strength (stability of a device) by adding a small amount of an impurity element other than Fe, Co, and Pt.

### Example 2

Example 2 relates to the first example embodiment. In Example 2, an FeCoPt alloy of thin film type was produced by sputtering.

First, sputtering targets, that is, iron (Fe), cobalt (Co), and platinum (Pt) were prepared. Fe, Co, and Pt were sputtered simultaneously (or “co-sputtered”) under an argon gas atmosphere to form an FeCoPt alloy film on a silicon substrate. At this time, the sputtering power was adjusted to set an atomic composition ratio to Fe:Co:Pt=0.746:0.246:0.008.

Then, the silicon substrate formed with the FeCoPt alloy film was annealed at 600° C. in vacuum, whereby preparing a thin film of the FeCoPt alloy.

At the time of co-sputtering Fe, Co, and Pt, for example, it is possible to change a coercive force of the FeCoPt alloy and to enhance the strength (stability of a device) by adding a small amount of an impurity element other than Fe, Co, and Pt.

### Example 3

Example 3 relates to the second example embodiment. In Example 3, an FeCoAu alloy of bulk type was produced by sintering.

First, metal powders of iron (Fe), cobalt (Co), and gold (Au) were blended with an atomic composition ratio of Fe:Co:Au=0.746:0.246:0.008 and were uniformly mixed with a mortar to prepare a mixed powder.

Next, in a sintering device where argon gas was introduced after vacuum drawing, the prepared mixed powder was subjected to press molding at a pressure of 100 MPa and then sintered at 600° C. to form a sintered body.

Then, the sintered body was diced to a desired size, whereby producing an FeCoAu alloy having the desired size.

At the time of preparing the mixed powder, for example, it is possible to change a coercive force of the FeCoAu alloy and to enhance the strength (stability of a device) by adding a small amount of an impurity element other than Fe, Co, and Au.

### Example 4

Example 4 relates to the second example embodiment. In Example 4, an FeCoAu alloy of thin film type was produced by sputtering.

First, sputtering targets, that is, iron (Fe), cobalt (Co), and gold (Au) were prepared. Fe, Co, and Au were co-sputtered under an argon gas atmosphere to form an FeCoAu alloy film on a silicon substrate. At this time, the sputtering power was adjusted to set an atomic composition ratio to Fe:Co:Au=0.746:0.246:0.008.

Then, the silicon substrate formed with the FeCoAu alloy film was annealed at 600° C. in vacuum, whereby preparing a thin film of the FeCoAu alloy.

At the time of co-sputtering Fe, Co, and Au, for example, it is possible to change a coercive force of the FeCoAu alloy and to enhance the strength (stability of a device) by adding a small amount of an impurity element other than Fe, Co, and Au.

### Example 5

Example 5 relates to the third example embodiment. In Example 5, an FeCoIr alloy of bulk type was produced by sintering.

First, metal powders of iron (Fe), cobalt (Co), and iridium (Ir) were blended with an atomic composition ratio of Fe:Co:Ir=0.729:0.229:0.042 and were uniformly mixed with a mortar to prepare a mixed powder.

Next, in a sintering device where argon gas was introduced after vacuum drawing, the prepared mixed powder was subjected to press molding at a pressure of 100 MPa and then sintered at 600° C. to form a sintered body.

Then, the sintered body was diced to a desired size, whereby producing an FeCoIr alloy having the desired size.

At the time of preparing the mixed powder, for example, it is possible to change a coercive force of the FeCoIr alloy and to enhance the strength (stability of a device) by adding a small amount of an impurity element other than Fe, Co, and Ir.

### Example 6

Example 6 relates to the third example embodiment. In Example 6, an FeCoIr alloy of thin film type was produced by sputtering.

First, sputtering targets, that is, iron (Fe), cobalt (Co), and iridium (Ir) were prepared. Fe, Co, and Ir were co-sputtered under an argon gas atmosphere to form an FeCoIr alloy film on a silicon substrate. At this time, the sputtering power was adjusted to set an atomic composition ratio to Fe:Co:Ir=0.729:0.229:0.042.

Then, the silicon substrate formed with the FeCoIr alloy film was annealed at 600° C. in vacuum, whereby preparing a thin film of the FeCoIr alloy.

At the time of co-sputtering Fe, Co, and Ir, for example, it is possible to change a coercive force of the FeCoIr alloy and to enhance the strength (stability of a device) by adding a small amount of an impurity element other than Fe, Co, and Ir.

### Example 7

Example 7 relates to the fourth example embodiment. In Example 7, an FeCoPtAu alloy of bulk type was produced by sintering.

First, metal powders of iron (Fe), cobalt (Co), platinum (Pt), and gold (Au) were blended with an atomic composition ratio of Fe:Co:Pt:Au=0.75:0.25:0.02:0.04 and were uniformly mixed with a mortar to prepare a mixed powder.

Next, in a sintering device where argon gas was introduced after vacuum drawing, the prepared mixed powder was subjected to press molding at a pressure of 100 MPa and then sintered at 600° C. to form a sintered body.

Then, the sintered body was diced to a desired size, whereby producing an FeCoPtAu alloy having the desired size.

At the time of preparing the mixed powder, for example, it is possible to change a coercive force of the FeCoPtAu alloy and to enhance the strength (stability of a device) by adding a small amount of an impurity element other than Fe, Co, Pt, and Au.

### Example 8

Example 8 relates to the fourth example embodiment. In Example 8, an FeCoPtAu alloy of thin film type was produced by sputtering.

First, sputtering targets, that is, iron (Fe), cobalt (Co), platinum (Pt), and gold (Au) were prepared. Fe, Co, Pt, and Au were co-sputtered under an argon gas atmosphere to form an FeCoPtAu alloy film on a silicon substrate. At this time, the sputtering power was adjusted to set an atomic composition ratio to Fe:Co:Pt:Au=0.75:0.25:0.02:0.02.

Then, the silicon substrate formed with the FeCoPtAu alloy film was annealed at 600° C. in vacuum, whereby preparing a thin film of the FeCoPtAu alloy.

At the time of co-sputtering Fe, Co, Pt, and Au, for example, it is possible to change a coercive force of the FeCoPtAu alloy and to enhance the strength (stability of a device) by adding a small amount of an impurity element other than Fe, Co, Pt, and Au.

### Example 9

Example 9 relates to the fourth example embodiment. In Example 9, an FeCoPtIr alloy of bulk type was produced by sintering.

First, metal powders of iron (Fe), cobalt (Co), platinum (Pt), and iridium (Ir) were blended with an atomic composition ratio of Fe:Co:Pt:Ir=0.75:0.25:0.02:0.04 and were uniformly mixed with a mortar to prepare a mixed powder.

Next, in a sintering device where argon gas was introduced after vacuum drawing, the prepared mixed powder was subjected to press molding at a pressure of 100 MPa and then sintered at 600° C. to form a sintered body.

Then, the sintered body was diced to a desired size, whereby producing an FeCoPtIr alloy having the desired size.

At the time of preparing the mixed powder, for example, it is possible to change a coercive force of the FeCoPtIr alloy and to enhance the strength (stability of a device) by adding a small amount of an impurity element other than Fe, Co, Pt, and Ir.

### Example 10

Example 10 relates to the fourth example embodiment. In Example 10, an FeCoPtIr alloy of thin film type was produced by sputtering.

First, sputtering targets, that is, iron (Fe), cobalt (Co), platinum (Pt), and iridium (Ir) were prepared. Fe, Co, Pt, and Ir were co-sputtered under an argon gas atmosphere to form an FeCoPtIr alloy film on a silicon substrate. At this time, the sputtering power was adjusted to set an atomic composition ratio to Fe:Co:Pt:Ir=0.75:0.25:0.02:0.04.

Then, the silicon substrate formed with the FeCoPtIr alloy film was annealed at 600° C. in vacuum, whereby preparing a thin film of the FeCoPtIr alloy.

At the time of co-sputtering Fe, Co, Pt, and Ir, for example, it is possible to change a coercive force of the FeCoPtIr alloy and to enhance the strength (stability of a device) by adding a small amount of an impurity element other than Fe, Co, Pt, and Ir.

### Example 11

Example 11 relates to the fourth example embodiment. In Example 11, an FeCoAuIr alloy of bulk type was produced by sintering.

First, metal powders of iron (Fe), cobalt (Co), gold (Au), and iridium (Ir) were blended with an atomic composition ratio of Fe:Co:Au:Ir=0.75:0.25:0.02:0.04 and were uniformly mixed with a mortar to prepare a mixed powder.

Next, in a sintering device where argon gas was introduced after vacuum drawing, the prepared mixed powder was subjected to press molding at a pressure of 100 MPa and then sintered at 600° C. to form a sintered body.

Then, the sintered body was diced to a desired size, whereby producing an FeCoAuIr alloy having the desired size.

At the time of preparing the mixed powder, for example, it is possible to change a coercive force of the FeCoAuIr alloy and to enhance the strength (stability of a device) by adding a small amount of an impurity element other than Fe, Co, Au, and Ir.

### Example 12

Example 12 relates to the fourth example embodiment. In Example 12, an FeCoAuIr alloy of thin film type was produced by sputtering.

First, sputter targets, that is, iron (Fe), cobalt (Co), gold (Au), and iridium (Ir) were prepared. Fe, Co, Au, and Ir were co-sputtered under an argon gas atmosphere to form an FeCoAuIr alloy film on a silicon substrate. At this time, the sputtering power was adjusted to set an atomic composition ratio to Fe:Co:Au:Ir=0.75:0.25:0.02:0.04.

Then, the silicon substrate formed with the FeCoAuIr alloy film was annealed at 600° C. in vacuum, whereby preparing a thin film of the FeCoAuIr alloy.

At the time of co-sputtering Fe, Co, Au, and Ir, for example, it is possible to change a coercive force of the FeCoAuIr alloy and to enhance the strength (stability of a device) by adding a small amount of an impurity element other than Fe, Co, Au, and Ir.

### Example 13

Example 13 relates to the fourth example embodiment. In Example 13, an FeCoPtAuIr alloy of bulk type was produced by sintering

First, metal powders of iron (Fe), cobalt (Co), platinum (Pt), gold (Au), and iridium (Ir) were blended with an atomic composition ratio of Fe:Co:Pt:Au:Ir=0.75:0.25:0.02:0.02:0.04. The blended metal powders were uniformly mixed with a mortar to prepare a mixed powder.

Next, in a sintering device where argon gas was introduced after vacuum drawing, the prepared mixed powder was subjected to press molding at a pressure of 100 MPa and then sintered at 600° C. to form a sintered body.

Then, the sintered body was diced to a desired size, whereby producing an FeCoPtAuIr alloy having the desired size.

At the time of preparing the mixed powder, for example, it is possible to change a coercive force of the FeCoPtAuIr alloy and to enhance the strength (stability of a device) by adding a small amount of an impurity element other than Fe, Co, Pt, Au, and Ir.

### Example 14

Example 14 relates to the fourth example embodiment. In Example 14, an FeCoPtAuIr alloy of thin film type was produced by sputtering.

First, sputter targets, that is, iron (Fe), cobalt (Co), platinum (Pt), gold (Au), and iridium (Ir) were prepared. Fe, Co, Pt, Au, and Ir were co-sputtered under an argon gas atmosphere to form an FeCoAuIr alloy film on a silicon substrate. At this time, the sputtering power was adjusted to set an atomic composition ratio to Fe:Co:Pt:Au:Ir=0.75:0.25:0.02:0.02:0.04.

Then, the silicon substrate formed with the FeCoPtAuIr alloy film was annealed at 600° C. in vacuum, whereby preparing a thin film of the FeCoPtAuIr alloy.

At the time of co-sputtering Fe, Co, Pt, Au, and Ir, for example, it is possible to change a coercive force of the FeCoPtAuIr alloy and to enhance the strength (stability of a device) by adding a small amount of an impurity element other than Fe, Co, Pt, Au, and Ir.

The aforementioned Examples 1 to 14 are methods for producing the magnetic alloy materials according to the first to fourth example embodiments. Although specific parameters such as composition ratios, sintering temperatures, and annealing temperatures are described in Examples 1 to 14, those are shown for purposes of illustration but not limitation of parameters for producing the magnetic alloy materials according to the first to fourth example embodiments.

While the present invention has been particularly shown and described with reference to the example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2018-224571, filed on Nov. 30, 2018, the disclosure of which is incorporated herein in its entirety by reference.

### REFERENCE SIGNS LIST

10, 20, 30, 40 magnetic alloy material

What is claimed is:

1. A magnetic alloy material comprising
iron and cobalt as main components and
at least one element selected from the group consisting of platinum, gold, and iridium.

2. The magnetic alloy material according to claim 1, wherein
an atomic composition ratio of cobalt is equal to or more than 10 atomic percent and equal to or less than 90 atomic percent.

3. The magnetic alloy material according to claim 1, wherein
equal to or less than 6 atomic percent of platinum is added.

4. The magnetic alloy material according to claim 1, wherein
equal to or less than 4.4 atomic percent of gold is added.

5. The magnetic alloy material according to claim 1, wherein
equal to or less than 5.8 atomic percent of iridium is added.

6. The magnetic alloy material according to claim 1, wherein
at least two kinds of elements selected from the group consisting of platinum, gold, and iridium are added, each of the elements being contained in amount of equal to or more than 0.1 atomic percent.

7. The magnetic alloy material according to claim 6, wherein
equal to or more than 0.1 atomic percent and equal to or less than 6 atomic percent of platinum and equal to or more than 0.1 atomic percent and equal to or less than 5 atomic percent of gold are added.

8. The magnetic alloy material according to claim 6, wherein
equal to or more than 0.1 atomic percent and equal to or less than 6 atomic percent of platinum and equal to or more than 0.1 atomic percent and equal to or less than 6 atomic percent of iridium are added.

9. The magnetic alloy material according to claim 6, wherein
equal to or more than 0.1 atomic percent and equal to or less than 5 atomic percent of gold and equal to or more than 0.1 atomic percent and equal to or less than 6 atomic percent of iridium are added.

10. The magnetic alloy material according to claim 6, wherein
equal to or more than 0.1 atomic percent and equal to or less than 6 atomic percent of platinum, equal to or more than 0.1 atomic percent and equal to or less than 5 atomic percent of gold, and equal to or more than 0.1 atomic percent and equal to or less than 6 atomic percent of iridium are added.
